(19) United States
(12) Patent Application Publication
(10) Pub. No.: US 2005/0139108 A1
(43) Pub. Date: Jun. 30, 2005

(54) Preparation of a printing plate using an ink jet technique

(76) Inventors: Kevin B. Ray, Fort Collins, CO (US); John Kalamen, Loveland, CO (US)

Correspondence Address: RATNERPRESTIA, P.O. BOX 1596, WILMINGTON, DE, 19899, US

(21) Appl. No.: 10/747,566

(22) Filed: Dec. 29, 2003

(51) Int. Cl. B41C 1/10

(52) U.S. Cl. 101/465; 347/96

(57) ABSTRACT

A method for forming an image useful as a lithographic printing plate using an ink jet technique is disclosed. An imageable precursor that comprises an overlayer over a substrate is imaged with an imaging agent and developed with water or fountain solution. The overlayer comprises a thiosulfate-containing polymer. The imaging agent is a polar organic liquid comprising at least one functional group selected from hydroxyl, cyano, and lactone. The method retains the advantages of using data in digital form, yet does not require expensive and complex equipment for imaging. The imaged precursor can be developed with water or on press using fountain solution.

### FIELD OF THE INVENTION

The invention. relates to lithographic printing. In particular, this invention relates to a method for forming an image useful as a lithographic printing plate using ink jet imaging techniques.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. Typically, the ink is first transferred to an intermediate blanket, which in turn transfers the ink to the surface of the material upon which the image is to be reproduced.

Imageable precursors useful as lithographic printing plate precursors typically comprise an imageable layer applied over the hydrophilic surface of a substrate. The imageable layer includes one or more radiation-sensitive components, which may be dispersed in a suitable binder. Alternatively, the radiation-sensitive component can also be the binder material. Following imaging, either the imaged regions or the unimaged regions of the imageable layer are removed, revealing the underlying hydrophilic surface of the substrate. If the imaged regions are removed, the precursor is positive working. Conversely, if the unimaged regions are removed, the precursor is negative working. In each instance, the regions of the imageable layer (i.e., the image areas) that remain are ink-receptive, and the regions of the hydrophilic surface revealed by the developing process accept water and aqueous solutions, typically a fountain solution, and repel ink.

Imaging of the imageable precursor with ultraviolet and/or visible radiation typically has been carried out through a mask, which has clear and opaque areas. Imaging takes place in the regions under the clear areas of the mask but does not occur in the regions under the opaque areas. If corrections are needed, a new mask must be made. In addition, dimensions of the mask may change slightly due to changes in temperature and humidity. Thus, the same mask, when used at different times or in different environments, may give different results and could cause registration problems.

Direct digital imaging, which obviates the need for imaging through a mask, is becoming increasingly important in the printing industry. Imageable precursors for the preparation of lithographic printing plates have been developed for use with infrared lasers. Although direct digital imaging has eliminated the mask, the equipment required for imaging, known as a platesetter, is expensive and can be complex, requiring, for example, computer controlled high intensity lasers.

Imaged imageable precursors typically require processing in a developer to convert them to lithographic printing plates. Processing introduces additional costs in, for example, the cost of the developer, the cost of the processing equipment, and the cost of operating the process. However, on-press developable lithographic printing plate precursors can be directly mounted on a press after imaging and developed with ink and/or fountain solution during the initial press operation. These precursors do not require a separate development step before mounting on press. On press imaging, in which the precursor is both imaged and developed on press, eliminates mounting the precursor in a separate imaging device.

Thus, a need exists for a method for imaging a printing plate precursor that retains the advantages of using data in digital form and thus does not use a mask for imaging, yet does not require expensive and complex equipment. In addition, the precursors used in this method should be capable of being developed on press, so that neither a developer nor a separate development step is required. Preferably, the precursors should also be imageable on press.

### SUMMARY OF THE INVENTION

The invention is a method for forming an image, useful as a lithographic printing plate. The method comprise the steps of:
a) imaging an imageable precursor that comprises an overlayer over a substrate by imagewise applying an imaging agent to the overlayer and forming an imaged precursor comprising unimaged regions and complementary imaged regions in the overlayer; and
b) developing the imaged precursor with an aqueous liquid and removing the unimaged regions without removing the complementary imaged regions;
in which:
   the overlayer comprises a thiosulfate-containing polymer; and
   the imaging agent is selected from 1) polar organic liquids containing at least one functional group selected from hydroxyl, cyano, and lactone, and 2) mixtures of said polar organic liquids.

Typically, the imaging agent is selected from the group consisting of 1-methoxypropan-2-ol, 1-propanol, 2-propanol, methoxyethanol, butyrolactone, diacetone alcohol (4-hydroxy-4-methyl-2-pentanone), ethanol, acetonitrile, benzyl alcohol, phenoxyethanol, and mixtures thereof. Preferred imaging agents are alcohols, especially benzyl alcohol, phenoxyethanol, and mixtures thereof.

The method retains the advantages of using data in digital form, yet does not require expensive and complex equipment for imaging. The imaged precursor can be developed with water or on press using fountain solution. When the imaged precursor is developed on press, processors and developers are not required. Thus, in another aspect of the invention, development is carried out on press. In a further aspect, imaging is also carried out on press.

### DETAILED DESCRIPTION OF THE INVENTION

Unless the context indicates otherwise, in the specification and claims, the terms co-monomer, polar organic liquid, thiosulfate-containing polymer, Bunte salt, alcohol, coating solvent, and similar terms also include mixtures of such materials. Unless otherwise specified, all percentages are percentages by weight.

Imageable Precursor

Overlayer

The imageable precursor preferably has only one layer, the overlayer, over the substrate. The overlayer provides the printing surface for the resulting lithographic printing plate. After imaging, the unimaged regions of the layer can be washed off either with water or on press with fountain solution, leaving the imaged regions. Representative synthetic methods for making polymerizable monomers and polymers useful in the invention are disclosed in Zheng, U.S. Pat. Nos. 5,985,514; 6,162,578; and 6,136,503, the disclosures of which are all incorporated herein by reference.

The overlayer comprises a thiosulfate-containing polymer. The thiosulfate-containing polymer comprises units that comprise the thiosulfate group, represented by Structure I. 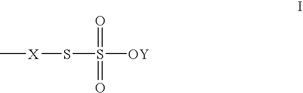
in which X is a divalent linking group that links the thiosulfate group to the polymer backbone, and Y is hydrogen. A thiosulfate group containing unit of the thiosulfate-containing polymer can be represented by the structure II in which the thiosulfate group is a pendant group: 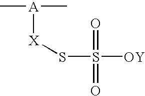
in which A represents a polymeric backbone.

The polymer must be either soluble in water or removable by water so that the imaged imageable precursor may be developed in water or in fountain solution. The polymer should have a molecular weight of about 38,000 to about 166,000. For optimum performance polymer should have a molecular weight of about 128,00 to about 151,000, as determined by size exclusion chromatography.

Depending on the nature of the co-monomer or co-monomers present in the thiosulfate-containing polymer, the thiosulfate-containing units typically comprise at least 10 mol %, preferably about 12 to 100 mol %, and more preferably, about 14 to about 50 mol % of the units in the polymer. The polymer may comprise more than one type of unit containing a thiosulfate group.

Linking groups include, for example, a single bond (i.e., the thiosulfate group is bonded directly to the polymer backbone), and substituted and unsubstituted alkylene groups, such as such as —(CH₂)ₙ—, in which n is 1 to 8, preferably 1 to 4, and —CH₂C(CH₃)₂CH₂—; substituted or unsubstituted phenylene [—(C₆H₄)—] groups, such as 1,2-, 1,3-, and 1,4-phenylene; substituted or unsubstituted naphthalene [—(C₁₀H₆)—] groups, such as 1,4-, 2,7-, and 1,8-naphthalene; substituted and unsubstituted aralkylene groups, such as 2-, 3-, and 4-C₆H₄CH₂— and 4-CH₂C₆H₄CH₂—. and —COO(Z)ₘ— in which m is 0 or 1, —(CH₂)ₙ— or phenylene, such as —CO₂—CH₂CH₂—.

Y is hydrogen; ammonium; a metal ion, such as lithium, sodium, potassium, magnesium, calcium, cesium, barium, zinc or lithium; or a substituted ammonium, preferably containing one to sixteen carbon atoms, such as methyl ammonium, dimethyl ammonium, trimethyl ammonium, tetramethyl ammonium, ethyl ammonium, diethyl ammonium, triethyl ammonium, tetraethyl ammonium, methyidiethyl ammonium, dimethylethyl ammonium, 2-hydroxyethyl ammonium, di-(2-hydroxyethyl) ammonium, tri-(2-hydroxyethyl) ammonium, tri-(2-hydroxyethyl)-methyl ammonium, 2-hydroxyethyl-dimethyl ammonium; n-propyl ammonium, di-(n-propyl) ammonium, tri-(n-propyl) ammonium, and tetra-(n-butyl) ammonium. Preferably, Y is hydrogen, a sodium ion, or a potassium ion.

Polymers containing thiosulfate groups can be prepared either by polymerization of a thiosulfate-containing monomer or by introduction of the thiosulfate group into a preformed polymer. The thiosulfate polymers may be addition homopolymers or copolymers or condensation type polymers, such as polyesters, polyimides, polyamides or polyurethanes. Useful polymeric backbones include, but are not limited to, vinyl polymers, polyethers, polyimides, polyamides, polyurethanes and polyesters. Preferably, the polymeric backbone is a vinyl (i.e., addition) polymer or a polyether.

Thiosulfate-containing molecules (or Bunte salts) can be prepared from the reaction between an alkyl halide and thiosulfate salt as taught by Bunte, Chem. Ber. 7, 646 (1884). For example, a thiosulfate-containing monomer can be prepared as illustrated below: 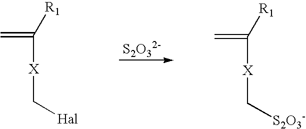
in which R₁ is hydrogen or an alkyl group, preferably hydrogen or methyl; Hal is halide, preferably chloro; and X is a divalent linking group.

Thiosulfate-containing polymers may be prepared by polymerization of a thiosulfate-containing monomer either by itself or with one or more co-monomers using methods, such as free radical polymerization, which are well known to those skilled in the art and which are described, for example, in Chapters 20 and 21, of Macromolecules, Vol. 2, 2nd Ed., H. G. Elias, Plenum, New York, 1984. Useful free radical initiators are peroxides such as benzoyl peroxide (BPO), hydroperoxides such as cumyl hydroperoxide and azo compounds such as 2,2′-azobis(isobutyronitrile) (AIBN). Suitable solvents include liquids that are inert to the reactants and which will not otherwise adversely affect the reaction. Typical solvents include, for example, esters such as ethyl acetate and butyl acetate; ketones such as methyl ethyl ketone, methyl isobutyl ketone, methyl propyl ketone, and acetone; alcohols such as methanol, ethanol, isopropyl alcohol, and butanol; ethers such as dioxane and tetrahydrofuran, and mixtures thereof.

Optional co-monomers include for example, acrylic acid; methacrylic acid; acrylate and methacrylate esters, such as methyl acrylate and methacrylate, ethyl acrylate and methacrylate, butyl acrylate and methacrylate, t-butyl acrylate and methacrylate, 2-hydroxyethyl methacrylate, 2-hydroxypropyl methacrylate, 2-ethoxyethyl acrylate and methacrylate, 2-(2-ethoxyethoxy)ethyl acrylate and methacrylate, 2-ethylhexyl acrylate and methacrylate, octyl acrylate and methacrylate, lauryl acrylate and methacrylate, 2-phenoxyethyl acrylate and methacrylate, benzyl acrylate and methacrylate, iso-bornyl acrylate and methacrylate, phenyl acrylate and methacrylate, 2-phenylethyl acrylate and methacrylate, and tetrahydrofurfuryl acrylate and methacrylate; acrylamides and methacrylamides, such as acryl and methacrylamide; vinyl ethers, such as methyl vinyl ether; vinyl esters, vinyl acetate; acrylonitrile; methacrylonitrile; and styrene and substituted styrenes.

Alternatively, thiosulfate-containing polymers may be prepared by polymerization of a precursor monomer, such as vinyl benzyl chloride, either by itself with one or more co-monomers using the methods described above, to form a precursor polymer. The precursor polymer can be converted to the thiosulfate-containing polymer as described, for example, by Vandengerg, U.S. Pat. No. 3,706,706.

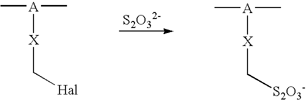

Thiosulfate-containing molecules can also be prepared by reaction of an alkyl epoxide with a thiosulfate salt, or between an alkyl epoxide and a molecule containing a thiosulfate moiety, such as 2-aminoethanethiosulfuric acid. The reaction can be carried out either on a monomer or a precursor polymer.

Preferred water soluble, hydrophilic polymers are co-polymers that have methyl methacrylate as the co-monomer having the following general composition: 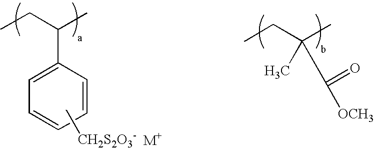
in which M⁺ is NH₄⁺ or Na⁺; and a: b is 1: 3.5 to 6.2 (i.e., the polymer contains about 14 mol % to 22 mol % thiosulfate-containing monomer).
   Substrate

The substrate comprises a support, which may be any material conventionally used to prepare imageable precursors or imageable precursors useful as lithographic printing plates. The support is preferably strong, stable and flexible. It should resist dimensional change under conditions of use so that color records will register in a full-color image. Typically, it can be any self-supporting material, including, for example, polymeric films such as polyethylene terephthalate film, ceramics, metals, or stiff papers, or a lamination of any of these materials. Metal supports include aluminum, zinc, titanium, and alloys thereof.

Typically, polymeric films contain a sub-coating on one or both surfaces to modify the surface characteristics to enhance the hydrophilicity of the surface, to improve adhesion to subsequent layers, to improve planarity of paper substrates, and the like. The nature of this layer or layers depends upon the substrate and the composition of the overlayer. Examples of subbing layer materials are adhesion-promoting materials, such as alkoxysilanes, aminopropyltriethoxysilane, glycidoxypropyltriethoxysilane and epoxy functional polymers, as well as conventional subbing materials used on polyester bases in photographic films.

The surface of an aluminum support may be treated by techniques known in the art, including physical graining, electrochemical graining, chemical graining, and anodizing. The substrate should be of sufficient thickness to sustain the wear from printing and be thin enough to wrap around a cylinder in a printing press, typically about 100 pm to about 600 pm. Typically, the substrate comprises an interlayer between the aluminum support and the overlayer. The interlayer may be formed by treatment of the aluminum support with, for example, silicate, dextrine, hexafluorosilicic acid, phosphate/fluoride, polyvinyl phosphonic acid (PVPA), vinyl phosphonic acid copolymers, or a water-soluble diazo resin.

The back side of the support (i.e., the side opposite the overlayer) may be coated with an antistatic agent and/or a slipping layer or matte layer to improve handling and “feel” of the imageable precursor.

Preparation of the Imageable Precursors

The imageable precursor may be prepared by applying the overlayer over the hydrophilic surface of the substrate using conventional techniques. The overlayer may be applied by any conventional method, such as coating or lamination. Typically the ingredients of the overlayer are dispersed or dissolved in a suitable coating solvent, such as water or a mixture of water and an organic solvent such as methanol, ethanol, iso-propyl alcohol, and/or acetone, and the resulting mixture coated by conventional methods, such as spin coating, bar coating, gravure coating, die coating, slot coating, or roller coating. After coating, the layer is dried to remove the coating solvent. The resulting imageable precursor may be air dried at ambient temperature or at an elevated temperature, such as at about 65° C. for about 20 seconds in an oven. Alternatively, the precursor may be dried by blowing warm air over the precursor. The composition can also be applied by spraying onto a suitable support, such as an on-press printing cylinder, as described in Gelbart, U.S. Pat. No. 5,713,287.

Imaging and Processing

An imaging agent is applied to the overlayer to form a latent image consisting of unimaged regions, i.e., regions to which imaging agent was not applied, and complementary imaged regions, i.e., regions to which the imaging agent has been applied. The latent image is converted to the image by removing the unimaged regions, revealing the surface of the underlying substrate, without removing the complementary imaged regions.

The imaging agent, a polar organic material that is a liquid at ambient temperature, typically comprises at least one hydroxyl group, cyano group, and/or lactone group. Mixtures of such polar organic liquids may also be used. Other functional groups, such as the ether group, the ketone group, or the ester group may also be present. However, hydrocarbons, such as hexane, toluene, and xylene; ethers, such as tetrahydrofuran; esters such as ethyl acetate; and ketones, such as 2-butanone, were found to be ineffective as imaging agents. Preferably, the imaging agent is volatile and/or sufficiently soluble in water that is removed either before and/or during the development process. Typically the imaging agent is selected from the group consisting of 1-methoxypropan-2-ol, 1-propanol, 2-propanol, methoxyethanol (ethylene glycol monomethyl ether), butyrolactone, diacetone alcohol, ethanol, acetonitrile, benzyl alcohol, phenoxyethanol, and mixtures thereof. Preferred imaging liquids include alcohols (i.e., liquids that comprise at least one hydroxyl group) and mixtures of alcohols, especially phenoxyethanol, benzyl alcohol, and mixtures thereof.

The imaging agent may be applied to the overlayer by any convenient technique. It may, for example, be applied with a cotton swab, such as those available under the name Q-TIP® applicators.

A preferred method of application is with an ink jet printer. Traditionally, digitally controlled inkjet printing uses one of two technologies, drop on demand printing and continuous ink-jet printing. Both technologies feed an imaging liquid, typically an ink, through channels formed in a print head. Each channel includes at least one nozzle from which droplets are selectively extruded and deposited upon a recording surface. Either type of printer may be used in the method of the invention.

In drop-on-demand systems, droplets are only generated and ejected through the print head when they are needed for imaging. Conventional drop-on-demand ink jet printers use a pressurization actuator to produce the droplet at an orifice of the print head. Typically, one of two types of actuators is used. With heat actuators, a heater heats the liquid causing a quantity to change to a gaseous steam bubble that raises the internal pressure sufficiently for a droplet to be expelled. With piezoelectric actuators, an electric field is applied to a piezoelectric material, creating a mechanical stress causing a droplet to be expelled.

Continuous stream or continuous ink jet printing, uses a pressurized source, which produces a continuous stream of droplets. Conventional continuous ink jet printers use electrostatic charging devices that are placed close to the point where a filament of liquid breaks into individual ink droplets. The droplets are electrically charged and then directed to an appropriate location by deflection electrodes having a large potential difference. When no imaging is desired, the droplets are deflected into a capturing mechanism and either recycled or disposed of. When imaging is desired, the droplets are not deflected, but are allowed to strike the recording surface. Alternatively, deflected droplets are allowed to strike the recording surface, while non-deflected droplets are collected in the capturing mechanism. Continuous ink-jet printers continuously produce smaller droplets for a generally higher resolution, but the imaging liquid must be able to be charged because the droplets are selectively deflected by electrostatic deflectors.

Suitable ink-jet printers for imagewise application of the imaging liquid may depend on the imaging liquid, and generally include the JetPlate ink-jet printer (Pisces-Print Imaging Sciences, Nashua, N.H., USA), the Xaarjet Evaluation Kit, (Xaarjet, Cambridge, UK), the Hewlett Packard DeskJet 970 CXI and Hewlett Packard 540C ink-jet printers (Hewlett Packard, Palo Alto, Calif., USA), the Epson Stylus Color 600, Epson 740, Epson 800, Epson Stylus Color 900, Epson Stylus PRO9600, Epson Stylus Color 3000 ink-jet printers (Epson, Long Beach, Calif., USA).

Following imaging, the precursor may be dried to remove at least part of the imaging agent. Drying may be carried out, for example, by air dying and/or by heating to about 65° C. for about 90 seconds.

Imaging produces an imaged precursor, which comprises a latent image of imaged regions and complementary unimaged regions. The imaged precursor contacted or washed with an aqueous liquid, such as water or fountain solution, either on press or in a conventional rinse/gum apparatus. The unimaged regions, that is, the regions of the overlayer that were not imaged with the imaging agent are removed. This process does not remove the imaged regions, that is, the regions of the overlayer that were imaged with the imaging agent.

The imaged imageable precursor may be developed in water. Although distilled or deionized water may be used, the imaged precursor typically can be developed in tap water. Although development with tap water will typically be carried out in a separate processor, rather than on press, it is not necessary to prepare and dispose of expensive, high pH developers when water is used. In addition, only a simple processor is necessary so expensive processors are not required to develop the imaged imageable precursor in water.

Alternatively, the imaged imageable precursor can be directly mounted on press after imaging and developed with fountain solution during the initial prints. No separate development step is needed before mounting on press. This eliminates the separate development step along with both the processor and developer, thus simplifying the printing process and reducing the amount of expensive equipment required. The imaged imageable precursor is mounted on the plate cylinder of a lithographic press and developed with fountain solution by rotating the press cylinders and contacting the precursor with fountain solution.

The imaged and developed precursor, i.e., the resulting printing plate may be heated following the development step to make the image more durable. Typically baking is carried out from abut 130° C. to about 170° C. for about 3 to about 5 minutes, to heating at about 210° C. to about 250° C. for about 5 to about 8 minutes.

For on-press imaging, the imageable precursor is imaged while mounted on a lithographic printing press cylinder, and the imaged imageable precursor is contacted with fountain solution during the initial press operation. This is especially suitable for computer-to-press applications in which the imageable precursor (or precursors, for multiple color presses) is directly imaged on the plate cylinder according to computer generated digital imaging information and, with minimum or no treatment, directly prints out regular printed sheets.

Fountain solutions are well known to those skilled in the art, and are disclosed, for example, in Matsumoto, U.S. Pat. No. 5,720,800; Archer, U.S. Pat. No. 5,523,194; Chase, U.S. Pat. No. 5,279,648; Bondurant, U.S. Pat. Nos. 5,268,025, 5,336,302, 5,382,298, Egberg, U.S. Pat. No. 4,865,646; and Daugherty, U.S. Pat. No. 4,604,952. Numerous aqueous fountain solutions are known to those skilled in the art. Typical ingredients of aqueous fountain solutions, in addition to water, typically deionized water, include pH buffering systems; desensitizing agents; surfactants and wetting agents; humectants, such as glycerin and sorbitol; low boiling solvents such as ethanol and 2-propanol; sequestrants, such as borax, sodium hexametaphosphate, and salts of ethylenediamine tetraacetic acid; biocides; and antifoaming agents. Typical pH ranges for fountain solutions are: about 3.7 to about 6.7 for sheet fed presses, and about 7.0 to about 9.6 for web presses.

In conventional wet press lithographic printing, fountain solution and then ink are applied to the printing plate. For presses with integrated inking/dampening system, the ink and fountain solution are emulsified by various press rollers before being transferred to the plate as emulsion of ink and fountain solution. However, in this invention, the ink and fountain solution may be applied in any combination or sequence, as needed for the plate.

Industrial Applidability

Once a lithographic printing plate precursor has been imaged and developed to form a lithographic printing plate, either off press or on press, printing can then be carried out. If imaging is carried off press, the imaged precursor is either developed off press and the resulting lithographic printing plate mounted on a press, or the imaged precursor is mounted on the press and developed with fountain solution. If imaging is carried out on press, the imaged precursor is developed on press with fountain solution.

Printing is carried out by applying fountain solution and then lithographic ink to the resulting image. Fountain solution is taken up by the surface of the hydrophilic substrate revealed by the imaging and development process, and the ink is taken up by the regions not removed by the development process. The ink is then transferred to a suitable receiving material (such as cloth, paper, metal, glass or plastic) either directly or indirectly using an offset printing blanket to provide a desired impression of the image thereon.

### EXAMPLES

The monomer ratio and molecular weight is shown for each of the thiosulfate-containing polymers (Bunte Salt).

Glossary

LODYNE® S-228M Anionic surfactant, blend of fluoro and silicone surfactants (Ciba Specialty Chemicals, Tarrytown, N.Y., USA)

Substrate A 0.3 mm thick aluminum sheet which had been electrograined, anodized and treated with a solution of polyvinylphosphonic acid 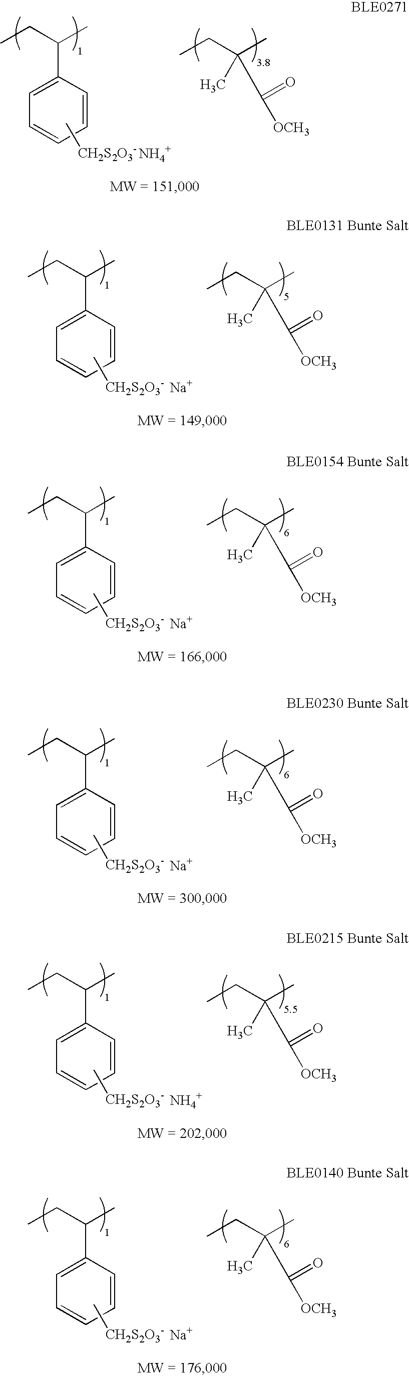 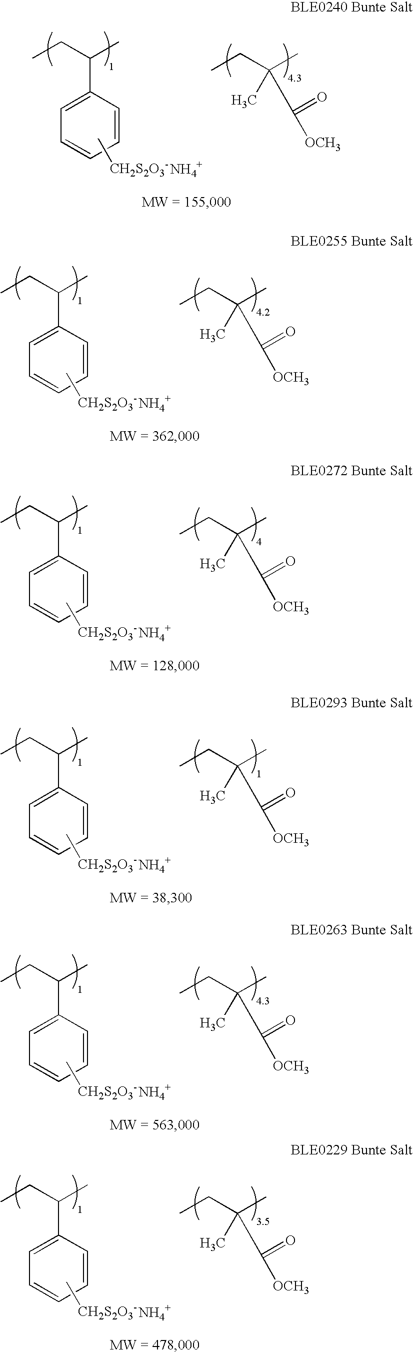
General Procedures

Unless otherwise indicated, the following procedures were used to prepare and evaluate the imageable precursors.

Preparation of the Polymers—The polymers were prepared by the free radical polymerization of vinyl benzyl chloride and methyl methacrylate using AIBN as the free radical generator. The resulting copolymer was treated with sodium thiosulfate to convert the chloro group to a thiosulfate group. This procedure is disclosed in Synthesis Example 3 of U.S. Pat. No. 6,162,578 and Synthesis Example 4 of U.S. Pat. No. 5,985,514. Both examples are incorporated herein by reference. Following this general procedure, the thiosulfate-containing polymers (Bunte Salts) shown above were prepared. Molecular weights were measured by size exclusion chromatography.

Preparation of the Imag able Precursors—A coating solution containing 99.5 parts by weight of the indicated thiosulfate-containing polymer (Bunte Salt) and 0.5 part LODYNE® S-228M in n-propanol/water (40:60, w:w) was coated onto substrate A with a wire wound bar. The resulting precursor, consisting of an overlayer on a substrate, was dried at 65° C. for 90 seconds.

Evaluation The resulting imageable precursor was treated with the indicated imaging agents. All the imaging agents were laboratory grade materials (Aldrich, Milwaukee, Wis., USA).

The imaging agent was applied to the overlayer using a cotton-tipped applicator swab. The imaged overlayer was allowed to air dry. The imaged overlayer was then drenched in tap water for 20 seconds and rubbed with a wet cotton pad for a further 10 seconds. For some of the imaging agents, the unimaged regions of the overlayer washed away and imaged regions resisted water development. For other imaging agents, no image discrimination was observed.

All the imaged imageable precursors in which image discrimination was observed were hand inked using the same wet pad that was used to remove the unimaged regions, but with printing ink applied. The ink stuck preferentially to the imaged regions. Unless “scumming” is indicated, the revealed aluminum substrate rejected the applied ink and remained clean. If scumming is indicated, the revealed aluminum substrate slightly accepted ink, but not to the extent that the image did.

Ink Jet Imaging A Xaarjet Ink Jet Device (Xaarjet Evaluation Kit, Model No. XJ126R, Xaarjet Cambridge, UK.) was used. The Xaarjet ink jet set-up consists of a PC-controlled imaging output device, a signal encoder that controls imaging head and the imaging head. The movement of the platten, which supports the substrate to be imaged, activates the imaging head. The fire frequency was set at 5 Hz, with an external trigger. The image control was “External SE”. The head was primed prior to imaging to ensure the ink jet fluid was continuous through the imaging head.

The imaging agent was decanted into the syringe system that supplies the ink jet device. The overlayer was placed on the platten and the platten moved to initiate the imaging mechanism. Where the overlayer had passed under the imaging head a clear and accurate copy of the image was formed. The imaged imageable precursor was allowed to dry in an oven (65° C. for 90 seconds).

The imaged imageable precursor was evaluated on an ABDick duplicator press (AB Dick, Niles, Ill., USA). The duplicator press was mounted with the test plate. The press was charged Van Son Rubber Base black Ink (Van Son Ink, Mineola, N.Y., USA). The aqueous fountain solution contained about 23.5 ml/L (3 oz per gallon) Varn Litho Etch142W (Varn International, Addison, Ill., USA), and about 23.5 ml/L (3 oz per gallon) Varn PAR (alcohol substitute) in water. This fountain solution had a pH of 4.

### Example 1

Following the General Procedures, imageable precursors in which the overlayer comprised BLE0271 were prepared and evaluated. The results are shown in Table 1.

TABLE 1

| Imaging Agent | Result |
|---|---|
| Hexane | No image discrimination seen |
| Toluene | No image discrimination seen |
| Ethyl Acetate | No image discrimination seen |
| Cyclohexanone | No image discrimination seen |
| 1-Methoxypropan-2-ol | Imaged region resisted water development |
| 1-Propanol | Imaged region resisted water development |
| 2-Propanol | Imaged region resisted water development |
| 2-Butanone | No image discrimination seen |
| Tetrahydrofuran | No image discrimination seen |
| Acetonitrile | Imaged region resisted development |
| 2-Methoxyethanol | Imaged region resisted development |
| Butyrolactone | Imaged region resisted development |
| 1,3-Dioxolane | No image discrimination seen |
| Xylene | No image discrimination seen |
| Ethanol | Imaged region resisted development |
| Diacetone alcohol | Imaged region resisted development |

### Example 2

The procedure was repeated, except that the coating weight of the overlayer was 1.0 g/m². The same results were observed.

### Example 3

Following the General Procedures, imageable precursors in which the overlayer comprised BLE0131 were prepared and evaluated. The results are shown in Table 2.

TABLE 2

| Imaging Agent | Result |
|---|---|
| Hexane | No image discrimination seen |
| Toluene | No image discrimination seen |
| Ethyl Acetate | No image discrimination seen |
| Cyclohexanone | No image discrimination seen |
| 1-methoxypropan-2-ol | Imaged region resisted development |
| 1-Propanol | Imaged region resisted development |
| 2-Propanol | Imaged region resisted development |
| Butyrolactone | Imaged region resisted development |
| Diacetone alcohol | Imaged region resisted development |

### Example 4

Following the General Procedures, imageable precursors in which the overlayer comprised BLE0154 were prepared and evaluated. The results are shown in Table 3.

TABLE 3

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | Imaged region resisted development | Scumming |
| 1-Methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |

### Example 5

Following the General Procedures, imageable precursors in which the overlayer comprised BLE0230 were prepared and evaluated. The results are shown in Table 4.

TABLE 4

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | No image discrimination seen | |
| 1-Methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |

### Example 6

Following the General Procedures, imageable precursors in which the overlayer comprised BLE0215 were prepared and evaluated. The results are shown in Table 5.

TABLE 5

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | Imaged region resisted development | Scumming |
| 1-Methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |

### Example 7

Following the General Procedures, imageable precursors in which the overlayer comprised BLE0140 were prepared and evaluated. The results are shown in Table 6.

TABLE 6

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | Imaged region resisted development | Scumming |
| 1-methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |
| Phenoxyethanol | Imaged region resisted development | Scumming |
| Benzyl alcohol | Imaged region resisted development | Scumming |

### Example 8

Following the General Procedures, imageable precursors in which the overlayer comprised BLE0240 were prepared and evaluated. The results are shown in Table 7.

TABLE 7

| Imaging Agent | Result |
|---|---|
| Hexane | No image discrimination seen |
| Toluene | No image discrimination seen |
| Ethyl Acetate | No image discrimination seen |
| Cyclohexanone | Imaged region resisted development |
| 1-Methoxypropan-2-ol | imaged region resisted development |
| 1-Propanol | Imaged region resisted development |
| I2-Propanol | Imaged region resisted development |
| Butyrolactone | Imaged region resisted development |
| Diacetone alcohol | Imaged region resisted development |
| Phenoxyethanol | Imaged region resisted development |
| Benzyl alcohol | Imaged region resisted development |

### Example 9

Following the General Procedures, imageable precursors in which the overlayer comprised BLE0255 were prepared and evaluated. The results are shown in Table 8.

TABLE 8

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | Imaged region resisted development | Scumming |
| 1-Methoxypropan-2-ol | Imaged region resisted development | Scumming |
| 1_Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |
| Phenoxethanol | Imaged region resisted development | Scumming |
| Benzyl alcohol | Imaged region resisted development | Scumming |

### Example 10

Following the General Procedures, imageable precursors in which the overlayer comprised BLE0272 were prepared and evaluated. The results are shown in Table 9.

TABLE 9

| Imaging Agent | Result |
|---|---|
| Hexane | No image discrimination seen |
| Toluene | No image discrimination seen |
| Ethyl Acetate | No image discrimination seen |
| Cyclohexanone | Imaged region resisted development |
| 1-Methoxypropan-2-ol | Imaged region resisted development |
| 1-Propanol | Imaged region resisted development |
| 2-Propanol | Imaged region resisted development |
| Butyrolactone | Imaged region resisted development |
| Diacetone alcohol | Imaged region resisted development |
| Phenoxyethanol | Imaged region resisted development |
| Benzyl alcohol | Imaged region resisted development |

### Example 11

Following the General Procedures, imageable precursors in which the overlayer comprised BLE0293 were prepared and evaluated. All the images were washed away by water.

### Example 12

Following the General Procedures, imageable precursors in which the overlayer comprised BLE0263 were prepared and evaluated. The results are shown in Table 10.

TABLE 10

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | Imaged region resisted development | Scumming |
| 1-Methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |
| Phenoxyethanol | Imaged region resisted development | Scumming |
| Benzyl alcohol | Imaged region resisted development | Scumming |

### Example 13

Following the General Procedures, imageable precursors in which the overlayer comprised BLE0229 were prepared and evaluated. The results are shown in Table 11.

TABLE 11

| Imaging Agent | Result | Comment |
|---|---|---|
| Hexane | No image discrimination seen | |
| Toluene | No image discrimination seen | |
| Ethyl Acetate | No image discrimination seen | |
| Cyclohexanone | No image discrimination seen | |
| 1-Methoxypropan-2-ol | Imaged region resisted development | Scumming |
| 1-Propanol | Imaged region resisted development | Scumming |
| 2-Propanol | Imaged region resisted development | Scumming |
| Butyrolactone | Imaged region resisted development | Scumming |
| Diacetone alcohol | Imaged region resisted development | Scumming |
| Phenoxyethanol | Imaged region resisted development | Scumming |
| Benzyl alcohol | Imaged region resisted development | Scumming |

### Example 14

Following the General Procedures, an imageable precursor of Example 1 was imaged with phenoxyethanol using an ink jet device. The image was found to be excellent in ink uptake and readily transferred the inked image to paper. The plate was capable of reproducing at least 250 impressions.

### Example 15

Following the General Procedures, an imageable precursor of Example 1 was imaged with benzyl alcohol using an ink jet device. The image was found to be excellent in ink uptake and readily transferred the inked image to paper. The plate was capable of reproducing at least 250 impressions.

### Example 16

Following the General Procedures, an imageable precursor of Example 10 was imaged with phenoxyethanol using an ink jet device. The image was found to be excellent in ink uptake and readily transferred the inked image to paper. The plate was capable of reproducing at least 250 impressions.

### Example 17

Following the General Procedures, an imageable precursor of Example 10 was imaged with benzyl alcohol using an ink jet device. The image was found to be excellent in ink uptake and readily transferred the inked image to paper. The plate was capable of reproducing at least 250 impressions.

Having described the invention, we now claim the following and their equivalents.

1. A method for forming an image comprising the steps of:
a) imaging an imageable precursor that comprises an overlayer over a substrate by imagewise applying an imaging agent to the overlayer and forming an imaged precursor comprising unimaged regions and complementary imaged regions in the overlayer; and
b) developing the imaged precursor with an aqueous liquid and removing the unimaged regions without removing the complementary imaged regions;
in which:
the overlayer comprises a thiosulfate-containing polymer; and
the imaging agent is selected from 1) polar organic liquids containing at least one functional group selected from hydroxyl, cyano, and lactone, and 2) mixtures of said polar organic liquids.

2. The method of claim 1 in which the imaging agent is selected from the group consisting of 1-methoxypropan-2-ol, 1-propanol, 2-propanol, methoxyethanol, butyrolactone, diacetone alcohol, ethanol, acetonitrile, benzyl alcohol, phenoxyethanol, and mixtures thereof.

3. The method of claim 1 in which the imaging liquid is selected from the group consisting benzyl alcohol, phenoxyethanol, and mixtures thereof.

4. The method of claim 1 in which the thiosulfate-containing polymer is a co-polymer that has the composition: 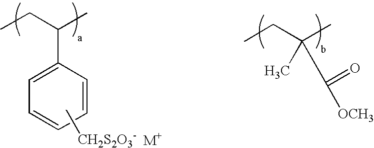
in which M⁺ is NH₄⁺ or Na⁺; and a: b is 1: 3.5 to 6.2.

5. The method of claim 4 in which the imaging agent is selected from the group consisting of 1 -methoxypropan-2-ol, 1 -propanol, 2-propanol, methoxyethanol, butyrolactone, diacetone alcohol, ethanol, acetonitrile, benzyl alcohol, phenoxyethanol, and mixtures thereof.

6. The method of claim 4 in which the imaging liquid is an alcohol or a mixture of alcohols.

7. The method of claim 6 in which the imaging liquid is selected from the group consisting benzyl alcohol, phenoxyethanol, and mixtures thereof.

8. The method of claim 1 in which the thiosulfate-containing polymer is a co-polymer has a molecular weight of about of about 128,00 to about 151,000.

9. The method claim 8 in which the thiosulfate-containing polymer is a co-polymer that has the composition: 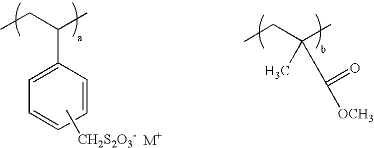
in which M⁺ is NH₄⁺ or Na⁺; and a: b is 1: 3.5 to 6.2.

10. The method of claim 9 in which the imaging agent is selected from the group consisting of 1-methoxypropan-2-ol, 1-propanol, 2-propanol, methoxyethanol, butyrolactone, diacetone alcohol, ethanol, acetonitrile, benzyl alcohol, phenoxyethanol, and mixtures thereof.

11. The method of claim 9 in which the imaging liquid is an alcohol or a mixture of alcohols.

12. The method of claim 11 in which the imaging liquid is selected from the group consisting benzyl alcohol, phenoxyethanol, and mixtures thereof.

13. The method of claim 1 in which the method additional comprises, after step b), the step of baking the imaged precursor.

14. The method claim 13 in which the thiosulfate-containing polymer is a co-polymer that has the composition: 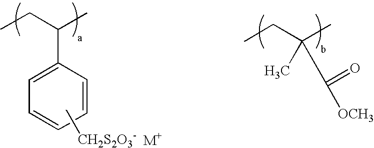
in which M⁺ is NH₄⁺ or Na⁺; and a: b is 1: 3.5 to 6.2; and
the thiosulfate-containing polymer is a co-polymer has a molecular weight of about of about 128,00 to about 151,000.

15. The method of claim 14 in which the imaging agent is selected from the group consisting of 1-methoxypropan-2-ol, 1-propanol, 2-propanol, methoxyethanol, butyrolactone, diacetone alcohol, ethanol, acetonitrile, benzyl alcohol, phenoxyethanol, and mixtures thereof.

16. The method of claim 14 in which the imaging liquid is an alcohol or a mixture of alcohols.

17. The method of claim 16 in which the imaging liquid is selected from the group consisting benzyl alcohol, phenoxyethanol, and mixtures thereof.

18. The method of claim 13 in which the imaging agent is selected from the group consisting of 1 -methoxypropan-2-ol, 1 -propanol, 2-propanol, methoxyethanol, butyrolactone, diacetone alcohol, ethanol, acetonitrile, benzyl alcohol, phenoxyethanol, and mixtures thereof.

19. The method of claim 13 in which the imaging liquid is an alcohol or a mixture of alcohols.

20. The method of claim 19 in which the imaging liquid is selected from the group consisting benzyl alcohol, phenoxyethanol, and mixtures thereof.
